(19) United States
(12) Patent Application Publication
(10) Pub. No.: US 2005/0191880 A1
(43) Pub. Date: Sep. 1, 2005

(54) Electronic card connector

(76) Inventor: Po-Hsiung Lin, Pingtung Hsien (TW)

Correspondence Address: RABIN & BERDO, P.C., Suite 500, 1101 14th STREET, N.W., Washington, DC, 20005, US

(21) Appl. No.: 10/787,747

(22) Filed: Feb. 27, 2004

(51) Int. Cl. H01R 12/00

(52) U.S. Cl. 439/82

(57) ABSTRACT

The electronic card connector of the present invention comprises an isolation chassis and a pair of metallic arms. The isolation chassis is made of an insulation material. The isolation chassis comprises a plurality of conductive terminals. A metallic arm is respectively fixed onto each of two ends of the isolation chassis. Each of the metallic arms extends downwardly and has a grounding portion and a welding portion for welding securely to the circuit board. Before attaching the electronic card connector to the circuit board, the welding portion of the metallic arm, which has a low melting point conductive metal, reduces the vertical height on the circuit board, when it gets liquefied due to heat in the convection reflow oven, and thus the connecting point on the circuit board and the welding portion of the metallic arm are electrically connected through the solder.

### BACKGROUND OF THE INVENTION

1. The Field of the Invention

The present invention relates to an electronic card connector, and more particularly relates to an electronic card connector having a chassis and metallic arms extending from two sides of the chassis.

2. Description of the Related Art

Nowadays the electronic products, such as computers, cellular phones, digital cameras and so on, are being popularly used. The functions of these products as well as the peripheral products thereof have been substantially increased. For these increased functionalities, the circuit and electronic component within the electronic products are accordingly complicated. While using the electronic products, interference among the components within the complicated circuit usually occurs undesirably impacting the quality of the electronic products. A filtering circuit or the like may be used to avoid or reduce such interferences. The circuit or electronic component used for avoiding or reducing interference of certain circuit from others commonly connects to a grounding circuit for maintaining the normal function of the circuit.

Commonly, every connecting point on the circuit board connecting to the electronic components, such as a electronic card connector but not limited to thereof, are being coated with semi-liquefied tin solder. After the electronic components are laid out onto the surface of the circuit board, the resulting circuit board is then transported via a conveying belt to a convection reflow oven where heating and liquefying of the tin solder takes place in order to weld the welding point of the circuit board and the electronic component together. And when the conveying belt transports the heated circuit board out of the convection reflow oven, the heated circuit board cools down and as a result the tin solder solidifies. Thus the solidified tin solder can serve as a media for the welding point of the circuit board and the electronic component together to have a secured electrical connection.

The two ends of the isolation case are designed to be inserted into the metallic arm and therefore this would easily cause cumulative structural intolerance, the planar intolerance of the two ends of the isolation case plus the intolerance of the metallic arm as the overall intolerance, thereby causing difficulty for the metallic arm to make a reliable electrical connection with the circuit board through the tin solder material.

Accordingly, a prior art proposed to design a vertical moveable fixing element that allowed the circuit board to move in a vertical direction for resolving the above intolerance problems.

The above fixing element is however made of a metallic material and can only move vertically in a certain range, therefore, it's not easy to manufacture and assemble such fixing element.

### SUMMARY OF THE INVENTION

The present invention provides an innovated cost effective electronic card connectors with metallic arms.

According to an aspect of the present invention, the electronic card connector has two metallic arms, which is electrically connected to the printed circuit board using a simple and reliable method.

The electronic card connector of the present invention comprises an isolation chassis and a pair of metallic arms. The isolation chassis is made of an insulation material. The isolation chassis comprises a plurality of conductive terminals. A metallic arm is respectively fixed onto each of two ends of the isolation chassis. Each of the metallic arms extends downwardly and has a grounding portion and a welding portion for welding securely to the circuit board. According to an aspect of the present invention, before attaching the electronic card connector to the circuit board, the welding portion of the metallic arm, which has a low melting point conductive metal, reduces the vertical height on the circuit board, when it, at least partial of it, gets liquefied due to heat in the convection reflow oven, and thus the connecting point on the circuit board and the welding portion of the metallic arm are electrically connected through the low melting point conductive metal and solder.

Because a low melting point conductive metal is set in the welding portion of the metallic arm, and therefore the welding portion of the metallic arm be securely welded to the grounding circuit of the circuit board, so that the two metallic arms can be simultaneously welded to the connecting points on the circuit board at the same time.

The low melting point conductive metal can be comprised of a metal or metal alloy, in the form of pellets, or powdery compounds obtained from the metallurgy method, such as tin alloy. Besides, the low melting point conductive metal, at least partial of it, has to be liquefied in the operating temperature condition of a common circuit board convection reflow oven. However, the evaporation temperature of the above low melting point conductive metal must be higher than the operating temperature condition of the common circuit board convection reflow.

### BRIEF DESCRIPTION OF THE DRAWING

For a more complete understanding of the present invention, reference will now be made to the following detailed description of preferred embodiments taken in conjunction with the following accompanying drawings.

FIG. 1 is an elevational view of an electronic card connector according to a preferred embodiment of the present invention.

FIG. 2 is a side view of the electronic card connector showing before reflow welding is performed according to a preferred embodiment of the present invention.

FIG. 3 is the side view of the electronic card connector showing after reflow welding is performed according to a preferred embodiment of the present invention.

FIG. 4 is a relative temperature curve showing a relationship of the temperature of the tin lead alloy with time on the conveying belt in a standard convection reflow oven.

FIG. 5 is the chart showing a relationship of the temperature of the tin lead alloy with time.

FIG. 6 is a relative temperature curve showing a relationship of a temperature of a pure tin (primarily applied in the lead free process of the printed circuit) with time on the conveying belt in a standard convection reflow oven.

FIG. 7 is an exploded view of the electronic card connector according to a preferred embodiment of the present invention.

FIG. 8 is an exploded view of the metallic arm of the electronic card connector according to a preferred embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

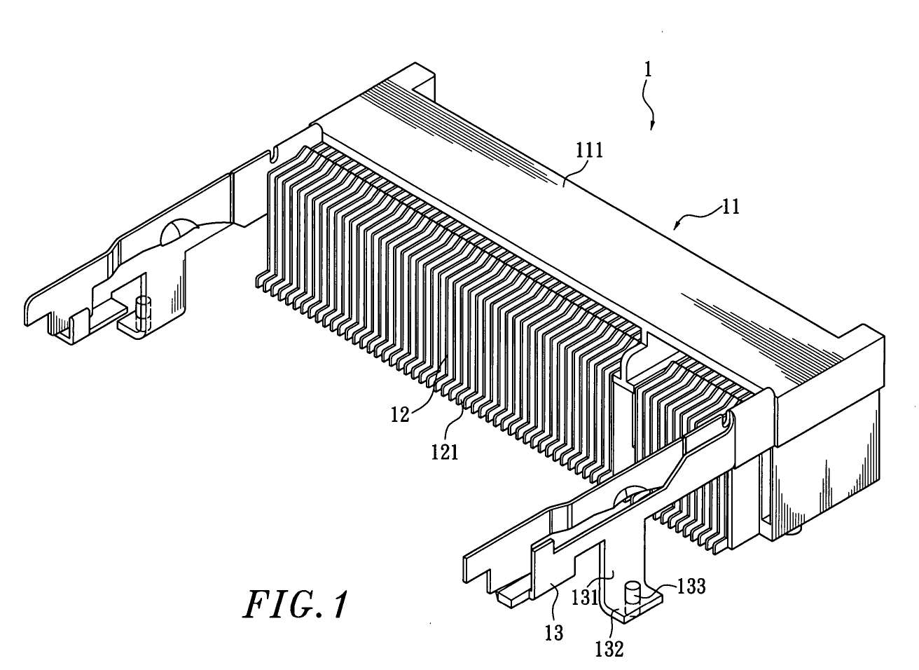

Referring to FIG. 1, an elevational view of an electronic card connector according to a preferred embodiment of the present invention is shown. The electronic card connector 1 of the present invention comprises an isolation chassis 11 and a base 111, which comprises a plurality of conductive terminals 12 penetrating therethrough. A distal end of each of the conductive terminal 12 comprises a welding portion 121. The two sides of the base 111 comprises parallel metallic arms 13 extending respectively, and each of the metallic arms 13 has a grounding portion 131 that extends downwardly. The grounding portion 131 is bent to form a welding portion 132, which has a low melting point conductive metal 133 that penetrate vertically through the hole formed on the welding portion 132.

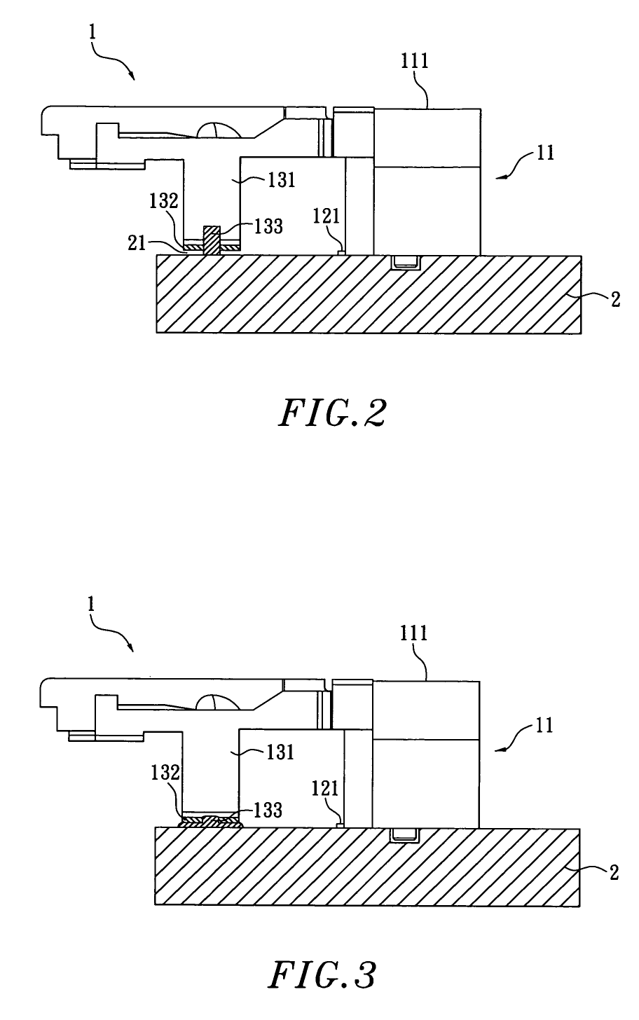

Referring to FIGS. 2 and 3, a side view showing the electronic card connector before reflow welding is performed, and a side view showing the electronic card connector after reflow welding is performed, according to a preferred embodiment of the present invention, respectively. Before welding the electronic card connector 1 onto a circuit board 2, the electronic card connector 1 is placed onto the circuit board 2. Because the welding portion 132, positioned at the lower portion of the grounding portion 131 of the two metallic arms 13, has the low melting point conductive metal 133 penetrating vertically through the hole, and therefore a gap 21 is formed between the welding portion 132 and the circuit board 2. When the electronic card connector 1 is heated in the convection reflow oven, the low melting point conductive metal 133 is melted and fills into the gap 21 between the welding portion 132 and the circuit board 2 and thereby reliably welds the electronic card connector 1 onto the circuit board 2. And because to the low melting point conductive metal 133 fills into the gap 21 between the welding portion 132 and the circuit board 2, thus the cumulative intolerance problem occurring between the two metallic arms 13 after assembly of the isolation chassis 11 and the two metallic arms 13 can be resolved. Further, the welding portion 132 below the grounding portion 131 of the two metallic arms 13, the welding portion 132 of the two metallic arms 13 and the welding portion 121 of the conductive terminal 12 can be electrically connected to the printed circuit board 2 by a simple and reliable method, soldering the connector onto a printed circuit board 2.

Furthermore, as described above, the electronic card connector 1 of the present invention is placed on the circuit board 2 and the resulting structure is then heated in the convection reflow oven where the low melting point conductive metal 133 is melted and fills into the gap 21 between the welding portion 132 and the circuit board 2, wherein the excess low melting point conductive metal 133 fills into the vertical hole of the welding portion 132. Accordingly, the above method not only allows the low melting point conductive metal 133 to have a sufficient adjustable space, but also reinforces the resistance of the electronic card connector 1 from being pulled off under external force.

The low melting point conductive metal 133 or the industrial welding material in the preferred embodiment of the present invention is formed protruded out of the button face of the welding portion 132 of the metallic arm 13, therefore, after the low melting point conductive metal 133 or the industrial welding material softens, the height of the two metallic arms 13 will be lower.

The low melting point conductive metal 133 can be a tin pellet or a tin-lead alloy, liquefiable in the operating temperature of a common circuit board convection reflow oven, so that the low melting point conductive metal 133 can be partially liquefied through the convection reflow oven due to the rapid heat conduction or the material characteristics.

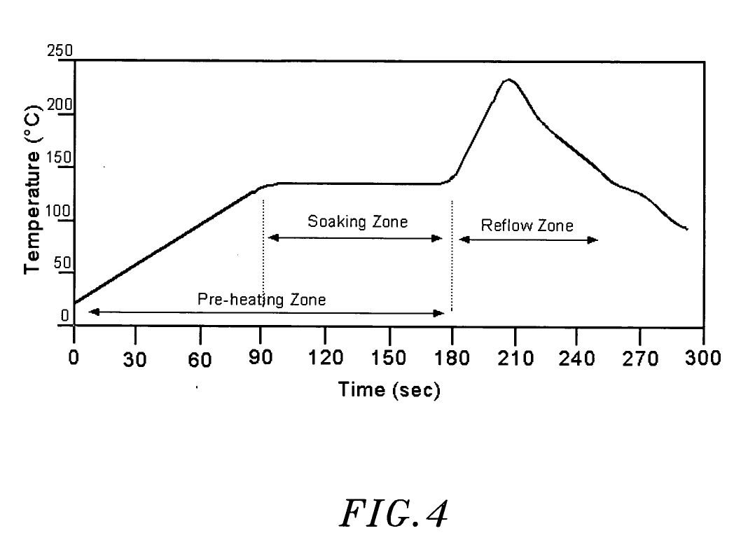

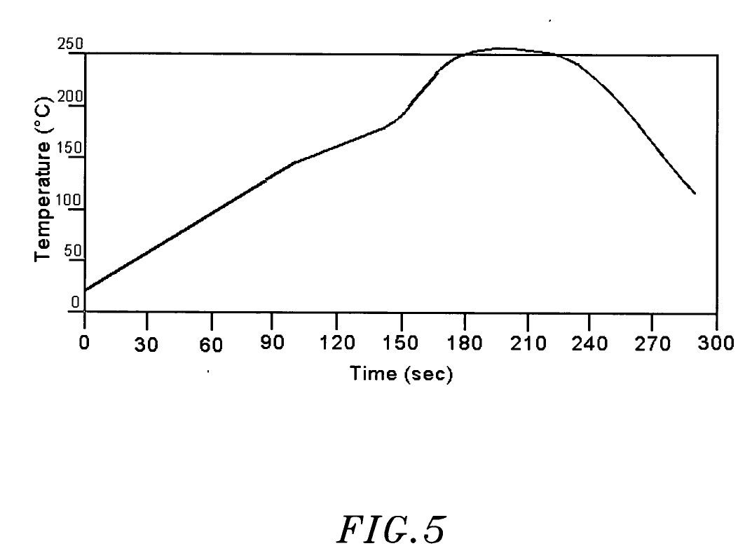

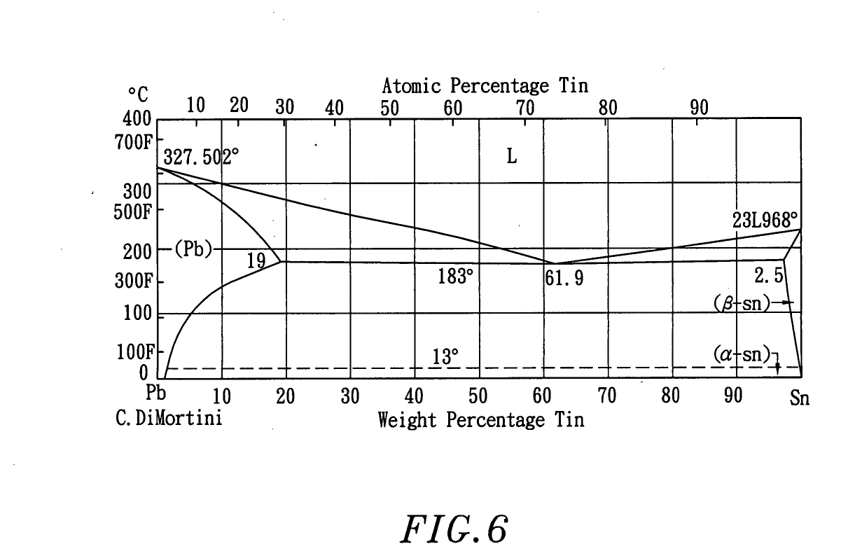

As shown in FIGS. 4, 5 and 6, most of the tin-lead alloy at 183° C. will be transformed from a solid state to a liquid state, and this temperature is within the operating temperature range of a common convection reflow oven. Therefore, at least most of the tin-lead alloy can be used as the low melting point conductive metal 133 in the present invention.

Recently, the environmental protection laws require that the circuit board should be produced in a lead free process. However, in the lead free process, the highest operating temperature of the convection reflow oven is over 250° C., which exceeds the melting point of a pure tin. Accordingly, a pure tin is used as the low melting point conductive metal 133 to meet the lead free process requirement.

Furthermore, because the usual low melting point conductive metal 133 generally has inferior mechanical characteristics at room temperature (high plasticity, poor surface hardness and poor elasticity), therefore after filling the low melting point conductive metal 133 or industrial melding material into the vertical hole of the welding portion 132, the deformation of the low melting point conductive metal 133 or industrial melding material can easily occur, and thus the low melting point conductive metal 133 or industrial melding material can be filled into the vertical hole of the welding portion 132 securely.

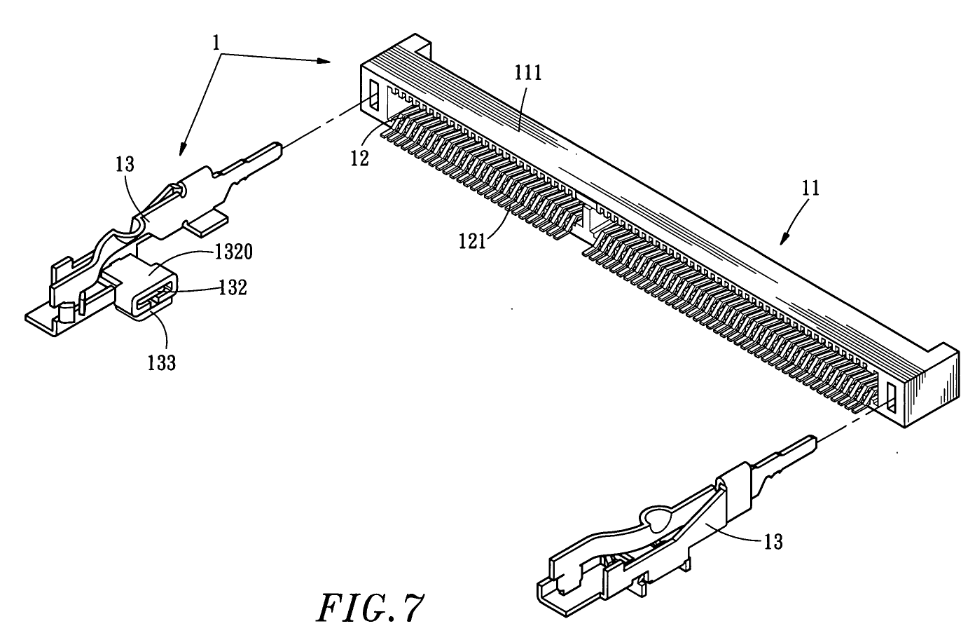

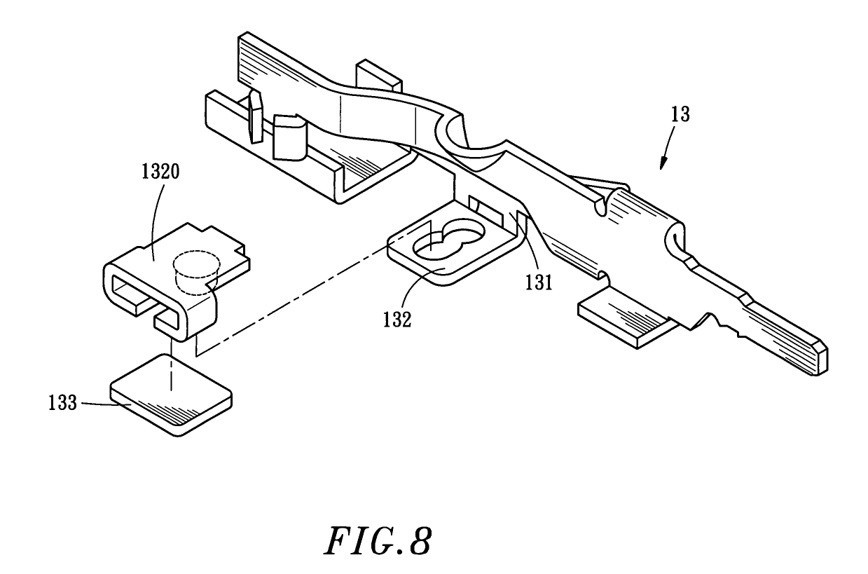

Further referring to FIGS. 7 and 8, the exploded view of the electronic card connector and the explored view of the metallic arm of the electronic card connector, according to a preferred embodiment of the present invention are shown. The grounding portion 131 of the metallic arm 13 is bent as a horizontal welding portion 132 that can be enclosed by a covering element 1320, and the covering element 1320 has the low melting point conductive metal 133 positioned at a bottom portion thereof. A gap is formed between the covering element 1320 and the welding portion 132 for vertical adjustment in a certain range. After heating the electronic card connector 1 in the convection reflow oven, the welding portion 121 of the conductive terminal 12 and the welding portion 132 of the metallic arm 13 can be welded onto the circuit board, and the gap between the covering element 1320 and the welding portion 132 of the metallic arm 13 allow the metallic arm 13 to move up or down to compensate any horizontal height difference from occurring during welding of the electronic card connector 1 to the metallic arm 13.

Accordingly, a person skilled in the art can easily use and apply the method, even when the low melting point conductive metal 133 or the industrial welding material is not formed protruding out of the bottom face of the welding portion 132 of the metallic arm 13. That is, under the above condition, the low melting point conductive metal 133 or the industrial welding material can still be softened by the heat of the convection reflow oven for welding and electrically connecting with the circuit board 2. However, the above depiction is still included within the scope of the present invention.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. An electronic card connector, comprising:
an isolation chassis, comprising two metallic arms parallel to each other, wherein said isolation chassis comprises a plurality of conductive terminals penetrating there-through, a distal end of each of said conductive terminals has a welding portion thereon, said two metallic arms respectively have a grounding portion extending downwardly and said grounding portion of two metallic arms has a welding portion having a low melting point conductive metal; and
wherein said electronic card connector is placed onto to a circuit board and heated to melt the low melting point conductive metal to securely weld said two metallic arms of electronic card connector to the circuit board.

2. The electronic card connector according to claim 1, wherein said low melting point conductive metal is comprised of a tin-lead alloy.

3. The electronic card connector according to claim 1, wherein in a lead free process of said printed circuit board, said low melting point conductive metal is comprised of a pure tin.

4. The electronic card connector according to claim 1, wherein said grounding portion is bent as said welding portion, which penetrates together with said low melting point conductive metal through a vertical hole thereof, is to reinforce resistance of said electronic card connector from any external pulling force.

5. The electronic card connector according to claim 1, wherein said grounding portion is bent as said welding portion, which is covered by a covering element, said covering element has a low melting point conductive metal at a bottom portion thereof, and a gap is formed between said covering element and welding portion for compensating a height difference, to allow the metallic arms to move vertically in a certain range.
